(19) United States
(12) Patent Application Publication
(10) Pub. No.: US 2007/0265887 A1
(43) Pub. Date: Nov. 15, 2007

(54) Integrated electronic business systems

(76) Inventors: Mark R. McLaughlin, Dubuque, IA (US); Edward D. Jones III, Seabrook Island, SC (US)

Correspondence Address: COURTNEY STANIFORD & GREGORY LLP, P.O. BOX 9686, SAN JOSE, CA, 95157, US

(21) Appl. No.: 11/799,781

(22) Filed: May 3, 2007

Related U.S. Application Data
(60) Provisional application No. 60/797,763, filed on May 3, 2006.

(51) Int. Cl. G06Q 10/00; G06Q 40/00

(52) U.S. Cl. 705/4; 705/2

(57) ABSTRACT

Embodiments of an electronic business process are described. The process comprises a remittance component for automatically converting paper and electronic remittance and payment data into validated electronic information that is compliant with HIPAA Administrative Simplification standards; an electronic health record component for updating personal and electronic health records of a patient receiving treatment from a health professional; and a dashboard component providing reporting functions to at least one of the patient, the health professional and a payer of fees for the treatment. The remittance component creates a balanced remittance that includes reason and remarks codes as pulled from the payer's explanation of benefits. A comparison of claim to remittance to payment is conducted prior to passing on to the provider's practice management system. The enhanced information is gathered in a centralized database to allow the system to create a remittance that will auto-post into the practice management system at a higher percentage than if only processing the payer's electronic remittance advice without the enhanced information.

### CROSS-REFERENCE TO RELATED APPLICATIONS

The present application claims the benefit of the U.S. Provisional Application No. 60/797,763 entitled “Integrated Electronic Business Systems,” and filed on May 3, 2006.

### FIELD

Embodiments of the invention relate generally to information systems, and more specifically, to gathering and sharing real-time payment information.

### BACKGROUND

In an effort to achieve efficiencies in the delivery of healthcare in the anticipated increase in use of Medicare resources beginning in 2011, the federal government is spurring increasing adoption of new technologies, such as “certified” electronic health records (EHRs), The federal government also is encouraging adoption of electronic business processes as part of its Administration Simplification regulatory requirements that are part of the Health Insurance Portability and Accountability Act of 1996 (HIPAA). These technology and regulatory initiatives affect all healthcare stakeholders, including covered entities such as health plans, healthcare clearinghouses, and healthcare providers; their business associates; patients; vendors of electronic healthcare service systems; and banks, which will process over $2 trillion of projected healthcare expenditures in the United States in 2006.

The push to adopt new technologies into the healthcare market has significantly increased the demand for remittance solutions by healthcare practitioners and increased the role of banks, especially large national banks, in the healthcare market. A continuation and acceleration of these activities is anticipated in support of new consumer-directed health plans, such as health savings accounts (HSAs) and in banks solidifying their healthcare customer bases by offering or facilitating the offering of electronic business solutions that minimize cost (health plans) and enhance cash flow (healthcare providers).

In addition to adoption of remittance solutions, the healthcare market is beginning to accelerate the deployment of electronic business applications that will be encapsulated in electronic health record and practice management systems for healthcare practitioners in both dental and medical arenas. Up until now, many electronic medical record (EMR) systems were nothing more than electronic filing cabinets in practitioners' offices. These systems must be distinguished from electronic health record (EHR) systems which can communicate data content between practitioners and between practitioners and patients, in an interoperable system.

Over the past several years, the demand for remittance solutions by healthcare practitioners and the increasing role of banks in the healthcare market have continued to increase. The anticipated continuation and acceleration of these activities in support of new consumer-directed health plans, such as health savings accounts (HSAs) and in banks solidifying their healthcare customer bases by offering or facilitating the offering of electronic business solutions that minimize cost (health plans) and enhance cash flow (healthcare providers) thus creates a need for new standard EHR applications, along with a need for integrated solutions in the form of electronic business applications configured for markets including the healthcare market.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a computer network system that implements embodiments of an electronic business process;

FIG. 2 illustrates the main functional components of the electronic business process of FIG. 1, under an embodiment.

FIG. 3 is a flow diagram of a provider practice management system (PMS) information flow within the electronic business system, under an embodiment.

FIG. 4 is a block diagram of the electronic business process and information flow, under an embodiment

FIG. 5 illustrates a process of registering providers to the system, under an embodiment.

FIG. 6 illustrates the features package of the electronic business process, under an embodiment.

FIG. 7 illustrates the organization of roles within a security model of the electronic business process, under an embodiment.

FIG. 8 illustrates the communication routes for the processing of claims within the electronic business process, under an embodiment.

FIG. 9 illustrates the communication routes for the processing of remittances within the electronic business process, under an embodiment.

FIG. 10 illustrates the organization and components of a data store for the electronic business process, under an embodiment.

FIG. 11 illustrates the functional components within the sponsor portal, under an embodiment.

FIG. 12 illustrates the request license pool process for a sponsor, according to an embodiment.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### DETAILED DESCRIPTION

Embodiments described herein, and referred to as “the electronic business process,” deliver to professional service providers (e.g., healthcare providers) electronic workflow solutions that automate administrative, financial, and clinical processes, comply with and are adaptable to future healthcare regulations and/or enhance reporting to facilitate fact-based, cost-effective decisions. The systems and methods of the electronic business process described herein, which include numerous hardware and/or software configurations, are configured to provide automated administrative processes, including, but not limited to, explanation of benefit (EOB) posting, secondary billings, coordination of benefits, denial and exception processing, reconciliation of EOBs with filed claims, and linking medical records, claims, EOB and electronic remittance advice (ERA), and other correspondence in one electronic “file cabinet.” It is anticipated that such systems in the medical industry alone may achieve savings of on the order or $30 billion annually at present rates. Under the methods of the electronic business process, savings or benefits accrue to payers in terms of reduced costs (delivery, provider relations, and appeals) and to providers in terms of improved cash flow, lower administrative costs, and easier and more-timely access to medical and administrative record information.

In the following description, numerous specific details are introduced to provide a thorough understanding of, and enabling description for, embodiments of an electronic business process. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

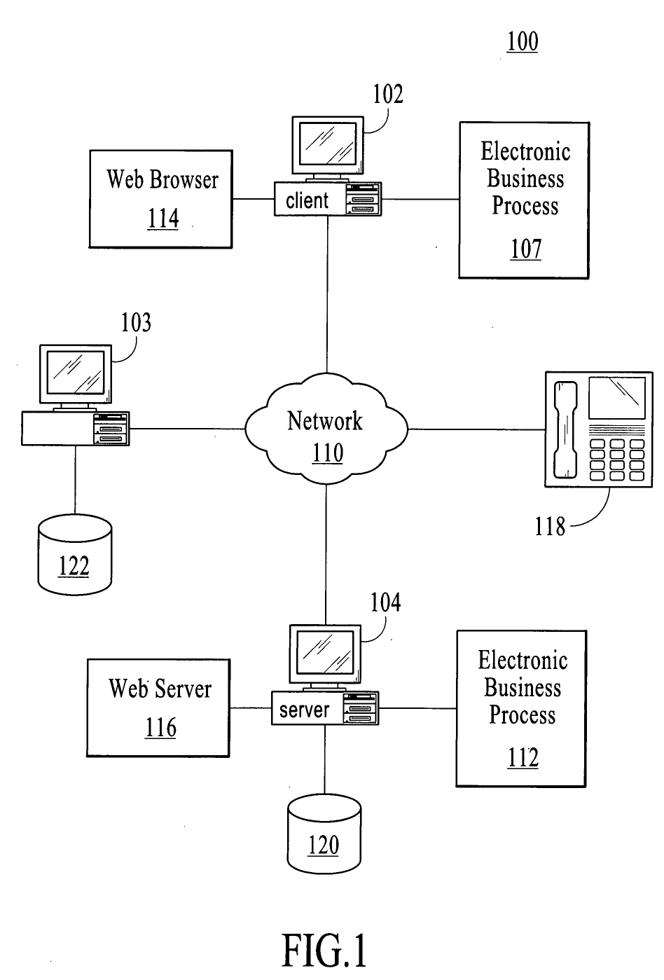

Aspects of the one or more embodiments described herein may be implemented on one or more computers executing software instructions. The computers may be networked in a client-server arrangement or similar distributed computer network. FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server side electronic business process 112. Client versions of this process 107 may also be executed on the client computers. This process may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the electronic business process 112 may be implemented in a plurality of different program modules, each of which may be executed by two or more distributed server computers coupled to each other, or to network 110 separately.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP). Data for any of the products or services processed by system 100, such as patient medical information, insurance data, payment records, and the like, may be provided by a data store 120 closely or loosely coupled to any of the server 104 and/or client 102. In one embodiment, the client computer may execute a client side electronic business process application program 107 to interact with the server-side electronic business process application 112. A separate content provider system 103 may provide some of the data that is included in the product offering or application process.

The client computer 102 may be a workstation computer or it may be a computing device such as a notebook computer, personal digital assistant, or the like. The client computer may also be embodied within a mobile communication device 118, cell phone, networked game console, or similar computing device that provides access to the Internet network 110 and a sufficient degree of user input and processing capability to execute or access the client-side electronic business process 107. The client computers 102 and 118 may be coupled to the server computer 104 over a wired connection, a wireless connection or any combination thereof.

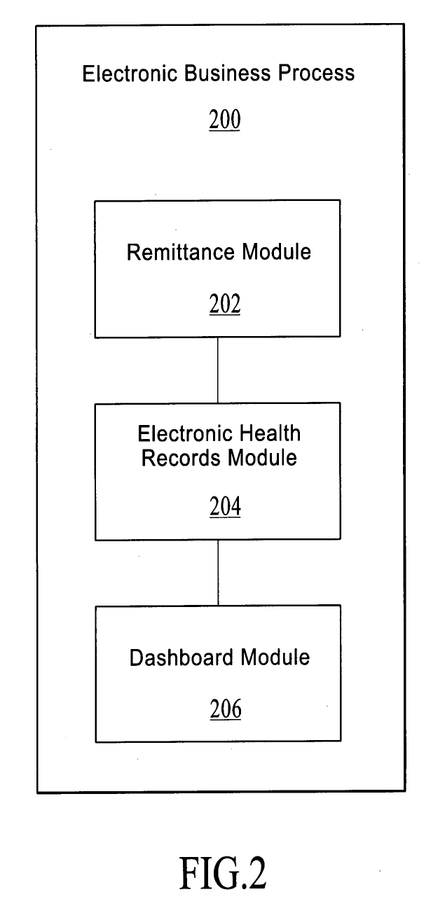

In one embodiment, as illustrated in FIG. 2, the electronic business process 200 includes three components referred to herein as the remittance module 202, the EHR (electronic health record) module 204, and the dashboard module 206. Each of the components can be used as a stand-alone component or integrated with any number and/or combination of other electronic business process components.

The remittance module (or component) 202, such as Application Service Provider (ASP) remittance solution, automatically converts paper and electronic remittance/payment data into validated electronic information that is compliant with HIPAA Administrative Simplification standards. The remittance component enables high-percentage auto-posting to healthcare provider practice management systems. The remittance component can be integrated into future “certified” electronic health record and practice management systems. The remittance component also includes one or more modules that provide “whole brain” visual information dashboards that facilitate fact-based, cost-effective decision making. The remittance component of an alternative embodiment supports Contract Management and Coordination of Benefits.

The EHR component 204 of the electronic business process is an electronic health records solution that supports personal health record (PHR) interoperability capability. The EHR component automates bi-directional update of personal and electronic health records and includes a biometric fingerprint capture that can be used to deter fraud and abuse in the healthcare system. The EHR component is configured to meet imminent federal government certification, integration, and interoperability requirements. In one embodiment, the EHR component compresses and expands DICOM™ (Digital Images and Communications in Medicine) images dynamically, and allows for seamless integration into practice management systems.

The dashboard component 206 includes “Whole brain” visual information executive decision support tools that integrate remittance, accounts receivable and other operational and financial data from the remittance 202 and EHR 204 components into interactive, graphical presentation for fact-based, enhanced decision making.

In general, the electronic business process described herein provides integration of administrative and clinical data in a one software-one database application. The electronic business process interactively communicates with other EHR systems and with emergent personal health record (PHR) systems on which patients maintain their medical records. The EHR component is anticipated to be “certified” by federal government sponsored, private sector developed certification requirements that are being developed certain entities, such as the CCHIT (Certification Commission for Healthcare Information Technology).

Users of the electronic business process include, for example, a healthcare provider that manages remittance and payment transactions either generated for or received by healthcare providers. The users can also include aggregators of remittance and payment transactions, including but not limited to banks and their lockbox utilities, covered entities (as defined by HIPAA Administrative Simplification), such as, healthcare providers, healthcare clearinghouses, health plans, and so on. The users can further include vendors of healthcare services (e.g., practice management systems, electronic health record systems, hospital information systems, etc.), medical societies, and onsite corporate health systems. Furthermore, users of the electronic business process include: providers that receive high volume paper remittances, especially from multiple sources and in different formats that require disparate processing and workflow procedures in the practice; providers that seek to increase efficiency, accuracy, and productivity, and to lower workflow costs in their payment posting process; and providers that seek and understand the need for better information and analytical tools for their revenue cycle management.

In general, the HIPAA regulations simplify the administration of the health care industry by creating unique identifiers for patients, providers, payers, and employers. Administration is simplified by enabling the efficient electronic transmission of health information, and costs are reduced by standardizing health care code sets and format. In general under the HIPAA system, an EDI (Electronic Data Interchange) Health Care Claim Transaction set (837) is used to submit health care claim billing information, encounter information, or both. It can be sent from providers of health care services to payers, either directly or via intermediary billers and claims clearinghouses. It can also be used to transmit health care claims and billing payment information between payers with different payment responsibilities where coordination of benefits is required or between payers and regulatory agencies to monitor the rendering, billing, and/or payment of health care services within a specific health care/insurance industry segment. Embodiments of the electronic business process are configured to integrate the processes of the different entities within the healthcare industry and create a fully-balanced, more completely coded HIPAA standard remittance file that can be auto-posted into any practice management system through simple user interface commands.

In one embodiment, the remittance module 202 integrates with an Optical Character Recognition (OCR) application that functions or assists in pulling data from paper claims, remittances, and explanation of benefits transactions. Additionally, the remittance module can be separate from and built on a proprietary database platform that ensures a high speed search and report capability. The remittance module of an embodiment also integrates with a “whole brained” dashboard module 206 that provides for the majority of the reporting functions provided by the system.

In an embodiment, the system makes use of information of the Implementation Guides for the HIPAA required transaction sets and addenda as adopted in 2002. The implementation guides include but are not limited to the following: (Accredited Standards Committee) ASC X12N 835 004010X091 and 004010X091A1 (Remittance); ASC X12N 837 004010X096 and 004010X096A1 (Institutional); ASC X12N 837 004010X098 and 004010X098A1 (Professional); and ASC X12N 837 004010X097 and 004010X097A1 (Dental).

In addition to the Implementation Guides, the following code sets are also used for the remittance transaction set of an embodiment: Claim Adjustment Reason Code; and Remittance Advice Remark Code.

While other known healthcare clearinghouses and practice management systems currently process remittance transactions, these systems typically only process what is sent by the payer. They do not scrutinize the information, which is often out of balance and contains the approved, generic reason and remarks codes listed above. Because the reason and remark codes are generic and are used differently by different payers, providers do not benefit from those codes. The result is a forced manual communication with the payers to more fully understand the reasons for payment discrepancies. In one embodiment, the remittance module 202 creates a balanced remittance that includes reason and remarks codes as pulled from the payers Explanation of Benefits (EOB). A comparison of claim to remittance to payment is conducted prior to passing on to the provider's practice management system. Because of the enhanced information is gathered in a centralized database, the system is able to create a remittance that will auto-post into the practice management system at a higher percentage than if only processing the payers ERA without the enhanced information.

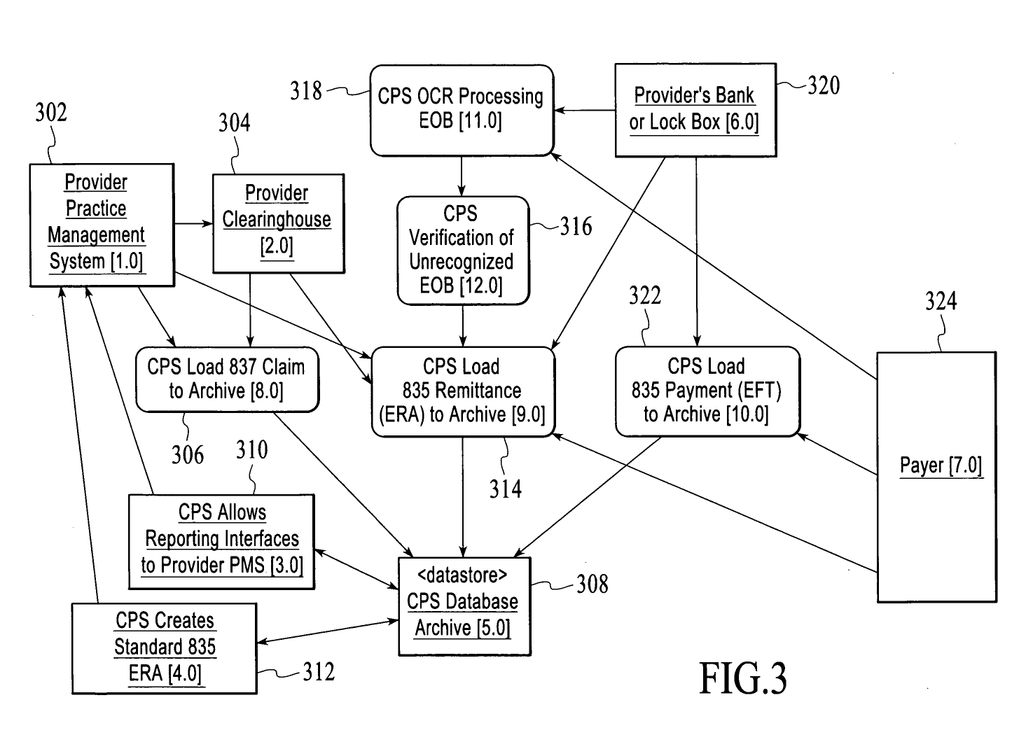

FIG. 3 is a flow diagram of a provider practice management system (provider PMS) information flow within the electronic business system, under an embodiment. As shown in FIG. 3, a provider practice management system 302 sends claims to the provider clearinghouse 304. The clearinghouse 304 performs editing on the claims and passes valid claims on to the payers 324. The remittance module loads a HIPAA standard claim (e.g., a HIPAA standard ASC X12N 837) to a database archive, block 306. The provider practice management system 302 then sends a copy of the claims to the remittance database archive 308. The remittance interface allows the provider to interact and retrieve dashboard reports via the web interface, block 310. The remittance module utilizes information from the EOB and remittance file received from the payer to create a standard, balanced 835 form that will auto-post into the provider's PMS accounts receivable (A/R) system, block 312. The provider's PMS interface may contain a remittance “button” that calls for the download of information. The “button” is unique to this system as it will allow an interface to any PMS that accepts electronic remittance. The provider practice management system loads an 835 remittance (ERA) to an archive, block 314. An additional option for the remittance receipt of payer remittance information is to receive a copy from the provider.

In block 306, the provider clearinghouse 304 loads an 837 claim to an archive. A copy of the claims is sent to the remittance module to be loaded into archive for future comparison to payment and remittance. The provider clearing house receives claims from the provider's PMS for subsequent editing and passing on to the payers. The provider clearinghouse 304 loads an 835 remittance (ERA) to an archive, block 314. A copy of the remittance is sent to the remittance module to be loaded into archive for future comparison to payment and claim data as well as utilizing the information for the creation of a standard, balanced 835. The dashboard module is configured to allow the provider web access to whole brain reporting tools that may be used for managing information relative to future claim submission, remittance history, diagnosis and procedure tracking and reporting by pre-defined region, and payment comparison by locale.

The database archive 308 allows reporting interfaces to the provider PMS 302. The dashboard web reporting interface extracts reporting data from the database archive. The database archive allows the web interface to request information via pre-created dashboard reports that also allow for interactive drill-down access to the underlying data. The remittance module creates a standard, balanced 835 from that will auto-post into the provider's PMS accounts receivable (A/R) system. The provider's PMS contains a remittance “button” that calls for the download of information and is interoperable with any PMS A/R system. The remittance archive supplies data to the provider PMS at the push of a button utilizing data gathered from the claim, EOB, electronic remittance advice, and payment information in the electronic funds transfer. Unbalanced or non-standard remittances may be received from several sources including the provider, provider's clearinghouse, payer, payer's EOB, or provider's bank or lock box 320. This information will be loaded into the database archive for future comparison to claim and payment information.

In block 314, the system performs verification of unrecognized EOB. A copy of remittance information is received from the EOB tool that allows for the recognition and extraction of information from a print-image EOB and subsequent population of the remittance database. The system sends all remittance information to the remittance database archive for future comparison to claim and payment information. A print image may be received and processed through an OCR (optical character recognition system), block 318. The system sends the print-image copy of the payer's EOB through the OCR engine where unrecognized characters will be handled with manual verification.

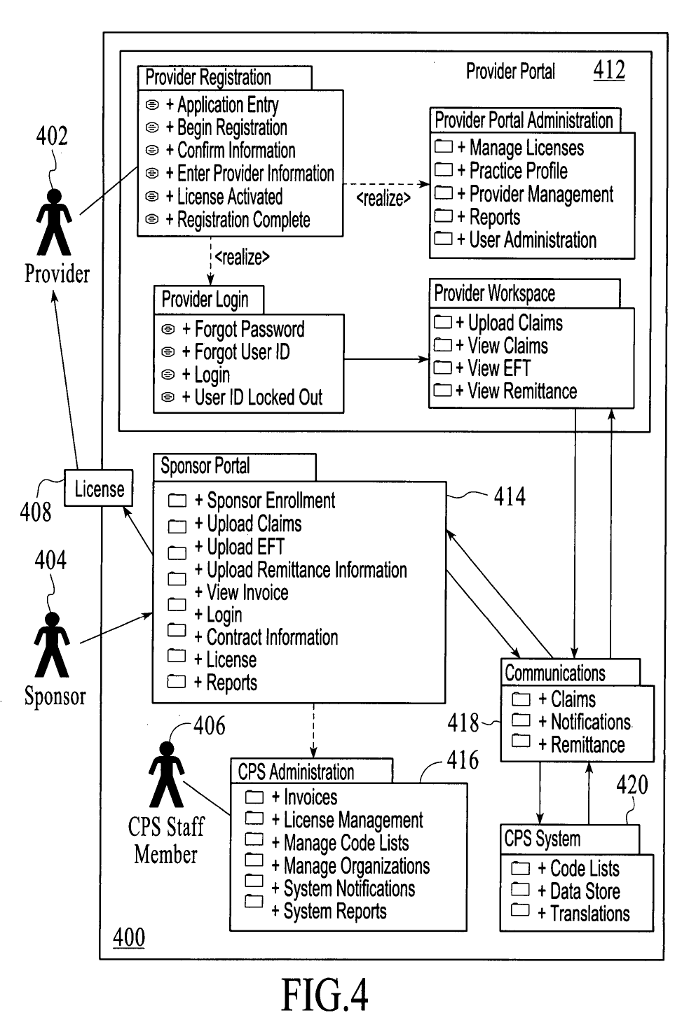

FIG. 4 is a block diagram of the electronic business process and information flow, under an embodiment. As shown in system 400, three separate entities access the components of system 400 through separate portals. A provider 402 accesses system 400 through provider portal 412. A provider 402 is an organization or individual that will utilize the license 408 of the remittance component either directly or on behalf of another organization. These organizations could be provider, billing services, large organizations having multiple locations. A sponsor 404 accesses the system 400 through a sponsor portal 414. A sponsor is an entity that has contracted the services of the system 400 or has purchased licenses 408 of the remittance, EHR, or dashboard components on behalf of another entity. The sponsor interacts with the provider through a communications module 418 that processes the claims, notifications, and remittances, and stores these data items within a CPS system module 420. A system administrator staff member 406 utilizes the administration area 416 for the purposes of administering data, assisting with customer service, running reports and monitoring the general health of the system 400. Another entity within the system is a payer (not shown), which is the entity responsible under HIPAA for creating/communicating the 835 remittance advice to the provider. The 835 remittance refers to an ASC X12N 835 file format.

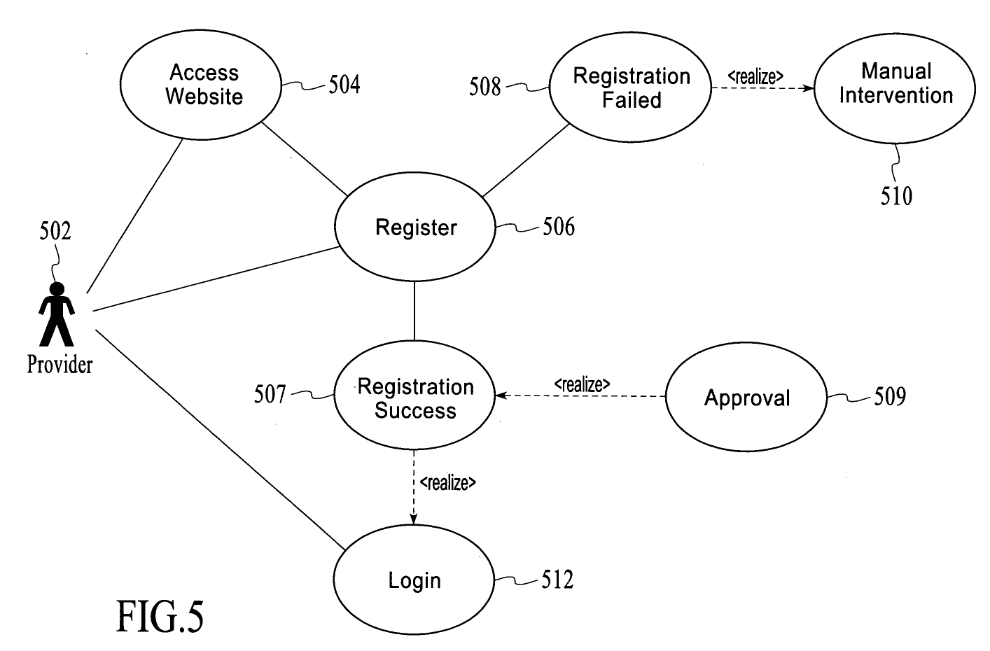

In one embodiment, the remittance, EHR, or dashboard license 408 is purchased by the sponsor and utilized by the provider. Providers are added to the system through a registration process. FIG. 5 illustrates a process of registering providers to the system, under an embodiment. In general a provider 502 will access the website at a pre-specified address, 504. If the provider has previously registered with the system and is a returning user, he or she simply logs in by entering a valid user ID and password, block 512. This provides access to the electronic business process site. The user ID is the ‘super user’ for the provider portal.

New providers without an account (specified by user name and password) will need to register to request access to the provider portal, block 506. The following information is required at the time of registration:
1. Organization Name
2. Provider First Name, MI, Last Name
3. Provider's Legal Designation
4. Organization Legal Address, City, State and Zip
5. Organization Phone Number
6. Organization Fax
7. Organization Email
8. Tax Identification Number (TIN), or Social Security No. (if sole proprietor)

Once the requisite registration information is provided, a drop down list with the network payer is shown. The user enters the payer's assigned provider ID (PIN). The provider's registration information is used to check against an aggregator's provider roster information if available. An approval process, block 509 utilizes the provider roster. The following data elements are checked:
Provider TIN—Tax Identification Number
Provider PIN—Payer Identification Number

If these two elements match the data entered in the registration, the registration process is successful, block 507, and the provider's organization is authorized to access the EDI system and provider portal. The provider may then log-in as a user, block 512.

The following items are checked for a positive match: PIN and TIN. If there is no aggregator, the TIN is checked for prior registration. If there is a prior registration, the registration will fail, block 508. A failed registration creates a JIRA ticket (or similar bug tracking flag) that is assigned to the lead support staff member for further action. In this case, the provider's organization registration information is placed into a queue for manual intervention, block 510.

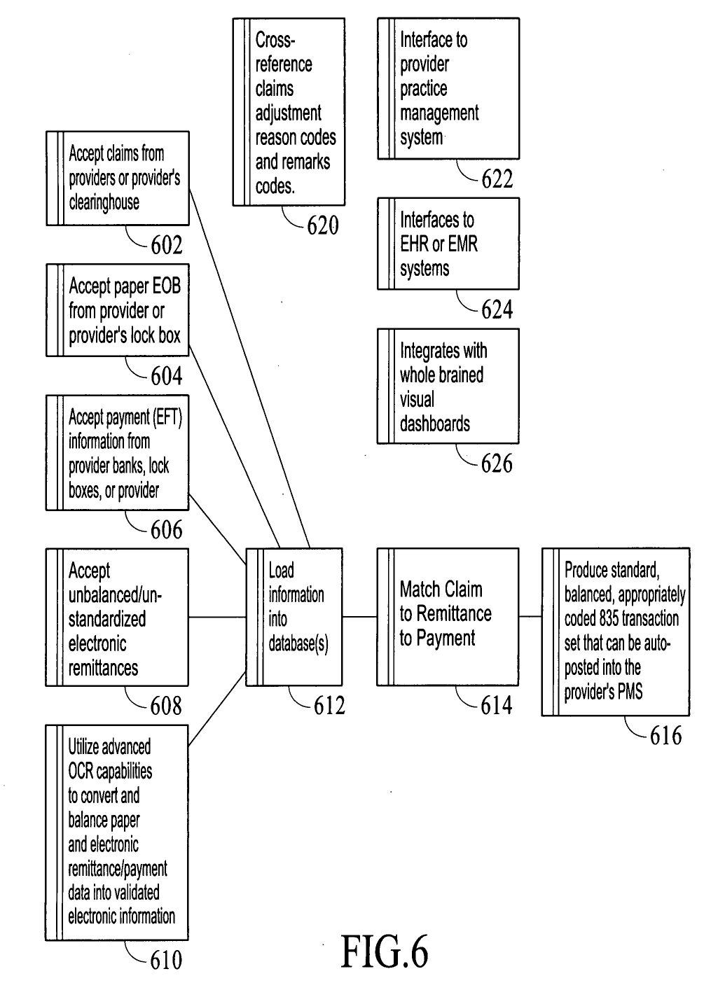

Within the electronic business process, features describe discrete pieces of functional behavior that yield a specific result. The features package of an embodiment includes features shown in FIG. 6, but is not so limited. As shown in FIG. 6, the functional behavior described by the features include the steps to: accept claims from providers or provider's clearinghouse, 602; accept paper EOB from provider or providers lock box, 604, accept payment (EFT) information from provider banks, lock boxes, or provider, 606; accept unbalanced/un-standardized electronic remittances, 608; utilize advanced OCR capabilities to convert and balance paper and electronic remittance/payment data into validated electronic information, 610. These features all produce information that is loaded into a database or databases, 612. The information is then used to match the claim to remittance and to payment, 614. This produces a standard, balanced and appropriately coded 835 transaction set that can be auto-posted into the provider's PMS, block 616. Other features of FIG. 6 include steps to cross-reference claims adjustment reason codes and remarks codes, 620, integrate with whole brained visual dashboards, 626, interface to provider practice management system, 622; and interface to EHR or EMR systems, 624.

Once a user logs in to the system, access is granted to system functionality by the user ID. The system functionality dictates each possible menu item, drop box, list selection, or push button. All access is defined by the system administrator. A basic access level can be defined for departments within an entity, and progressively detailed access levels can be defined for both role-based access and user-based access. Users may have multiple roles that can be defined individually or assigned to the user. A general role may have several roles. An access level database tracks each user ID and determines whether that role is assigned a general role. Each ID may have access to progressively more detailed system functionality.

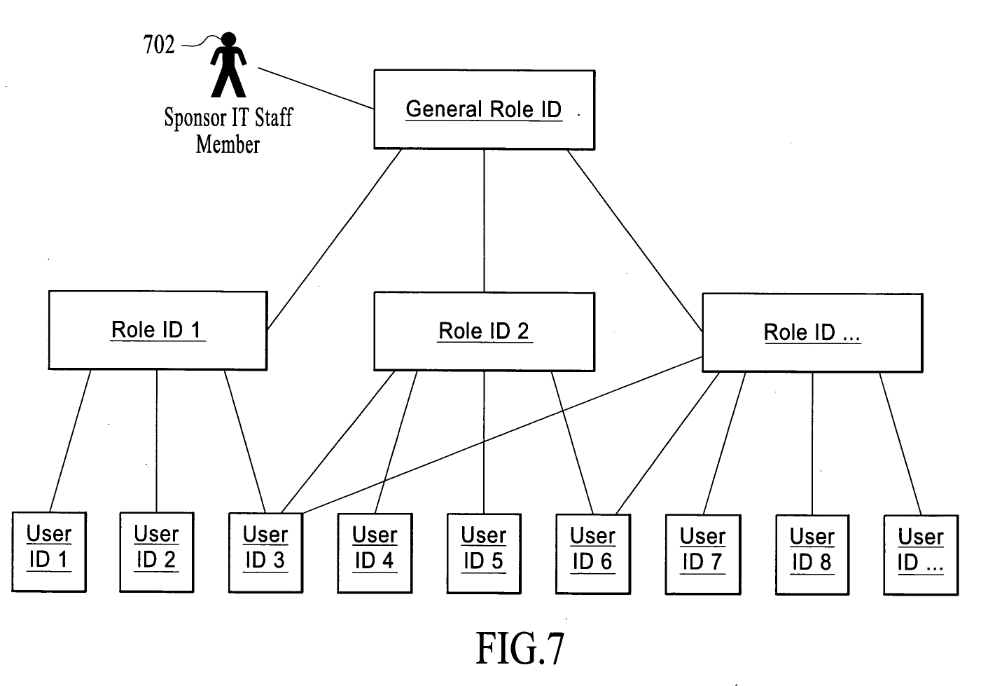

FIG. 7 illustrates the organization of roles within a security model of the electronic business process, under an embodiment. As shown in FIG. 7, a number of users, denoted User ID 1-8 and so on, are assigned to specific roles, each of which is assigned a role ID. Thus, for the example shown, Users 1, 2, and 3 are assigned Role ID1, Users 3-6 are assigned Role ID2, and so on. The individual role IDs can be assigned to a general role ID, which is managed by a staff member 702.

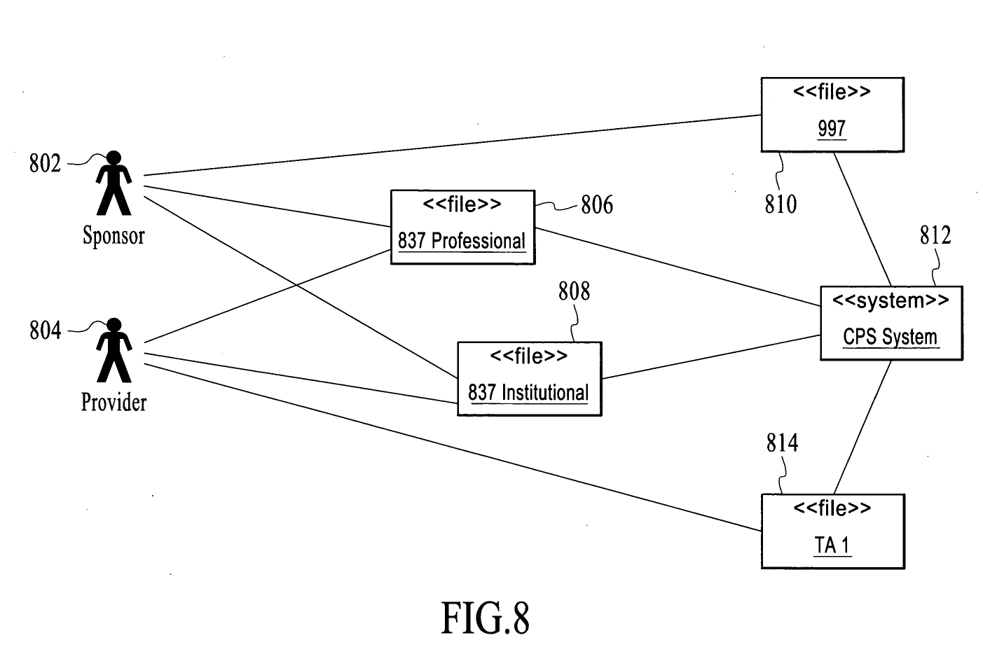

FIG. 8 illustrates the communication routes for the processing of claims within the electronic business process, under an embodiment. As shown in FIG. 8, both the sponsor 802 and provider 804 generate 837 Professional (806) and 837 Institutional (808) claims. The 837 Professional is an object in the form of an ASC X12N 837 for purposes of billing professional claims, and the 837 Institutional is an object in the form of an ASC X12N 837 for purposes of billing institutional claims. The sponsor 802 receives a 997 acknowledgement (810), which is an ASC X12N functional acknowledgement from the system 812. Likewise, the provider 804 receives a TA1 acknowledgement 814, which is an ASC X12N interchange acknowledgment from the system 812. Notifications are typically sent to the provider and sponsor through an e-mail via SMTP.

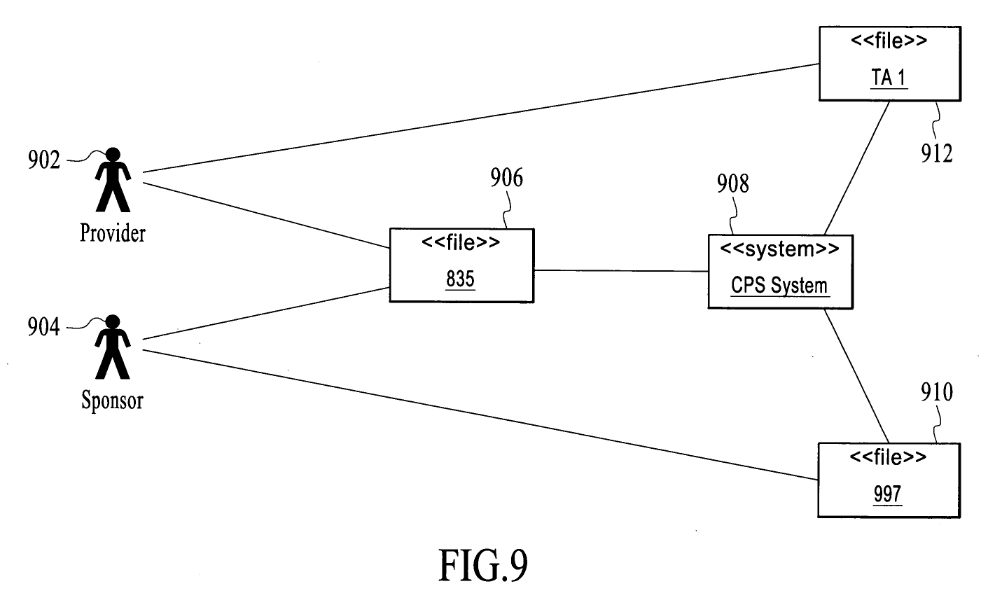

FIG. 9 illustrates the communication routes for the processing of remittances within the electronic business process, under an embodiment. As shown in FIG. 9, both the sponsor 904 and provider 902 receive 835 remittances, which are remittances in ASC X12N 835 file format, from the system 908. The sponsor 904 receives a 997 acknowledgement (910), which is an ASC X12N functional acknowledgement from the system 908. Likewise, the provider 902 receives a TA1 acknowledgement 912, which is an ASC X12N interchange acknowledgment from the system 908.

In one embodiment, use of the electronic business process by the provider is controlled through a license scheme 408, as illustrated in FIG. 4, and the remittance, EHR, or dashboard license 408 is purchased by the sponsor for utilization by the provider. For the administration of the electronic business process, a staff member performs certain administration tasks associated with license management that include generating keys, answering license requests, and determining/providing license pricing. The system creates invoices for licensing based on license generation, and system utilization (transaction volume). For security, licenses are controlled by a key based mechanism, and license keys are generated with specific logic. For example, upon enrollment the sponsor is given a 6-digit base number, each pool of licenses is given a 6-digit extension, and each license is given a 4-digit activation code. Licenses can be of various different formats. For example, in one embodiment, a license has the following structure: Sponsor 6 digit-License Pool 6 digit-4 digit Activation code.

The pricing model for license pools can vary depending upon actual implementation and requirements. For example, licenses are generally priced by the amount of licenses purchased. This is determined at the time of the license generation, and is used in billing for licenses.

To maintain compliance with government regulations, the electronic business process includes mechanisms to manage code lists. For example, as the HIPAA code lists are updated, the crosswalks to the sponsor's legacy code lists need to be updated and/or modified. In one embodiment, each sponsor's crosswalk is reviewed after each code list update where the crosswalk has a dependency to the specific code list. A staff member updates the HIPAA code lists as the new releases are available. There is a begin date and an end date for each list. In general, the list is available via the ASC X12 841 (EDI) transaction.

In certain circumstances, the system may need to ‘crosswalk’ between the HIPAA code sets and proprietary code sets. In general, these crosswalks are sponsor based, and there are one or more crosswalks per sponsor. The external HIPAA code sets include codes such as, provider taxonomy codes, claim adjustment reason codes, group codes, and so on. The claim adjustment reason codes communicate an adjustment, meaning that they must communicate why a claim or service line was paid differently than it was billed. If there is no adjustment to a claim/line, then there is no adjustment reason code. The remittance advice remark codes are used to convey information about remittance processing or to provide a supplemental explanation for an adjustment already described by a claim adjustment reason code. Each remittance advice remark code identifies a specific message as shown in the remittance advice remark code list. With regard to proprietary code sets, sponsors may have legacy codes sets that will need to be crosswalked/translated to the HIPAA code sets or vise versa. It is possible that the sponsor or provider will need the more detailed legacy code sent in their remittance file in order to eliminate the need to call the payer to discover the meaning of the currently generic HIPAA codes. Since the system is effectively acting in the role of a HIPAA Business Associate, it is afforded the ability to turn standard data into non-standard data (code sets) for any covered entity customers.

Along with the codes, organizations with the system may also change. The system displays the organizations within the system. The organizations are displayed by alphabetical order. The system has a quick search (autofill) that limits the list displayed. Once the organization is displayed the end user clicks on the organizations name to begin the editing process. The end user can update the following information for each organization: Organization Name, Organization Address, City/State/Zip, Phone Number, Organization Contact Name/Email/Phone/Fax, and Organization Tax Identification Number. The current default user ID is displayed. The end user is able to change the default or super user ID associated with the organization.

In one embodiment, critical system events are communicated to users through e-mail. The system may feature a user lockout notification mechanism, whereby the system emails the system administrator when a user ID is locked out. Certain system-level reporting functions can also be provided, such as bandwidth utilization per time period (e.g., 24-hour), CPU utilization, user activity, database health in terms of certain parameters (e.g., available disk space, response times, database size, and so on), and any other similar activity or characteristics.

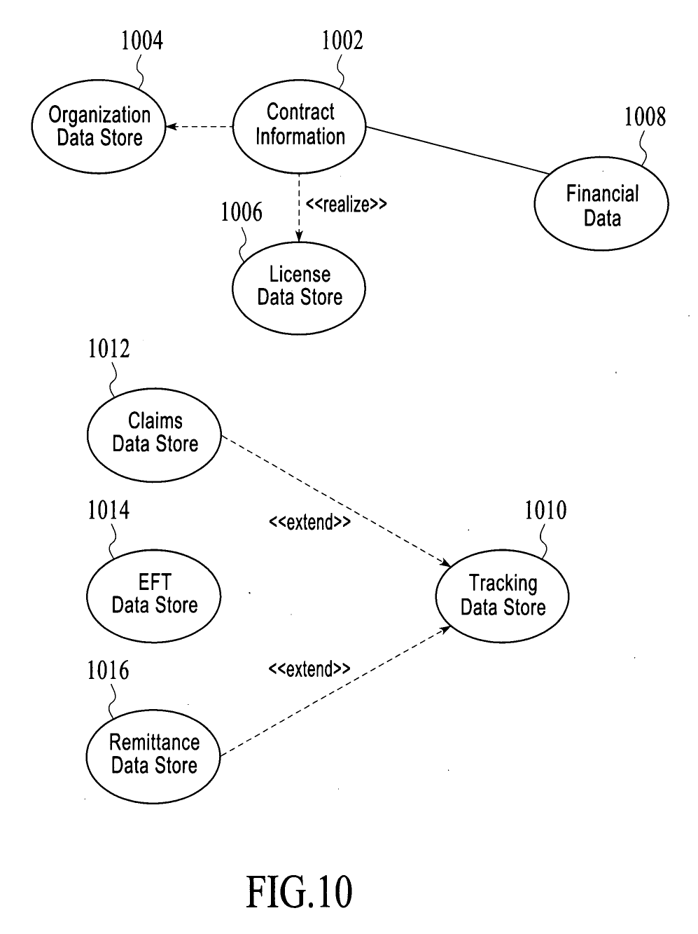

In one embodiment, claims data within the system is stored in both an original format, as well as in a relational data store optimized for data retrieval per business unit (claim). FIG. 10 illustrates the organization and components of a data store for the electronic business process, under an embodiment. An organization data store 1004 contains the contract information 1002 for each organization. The organization can be both a provider and a sponsor. This would include recording the acceptance of the business associate legal agreement, terms of use agreement, billing cycles, and other relevant information. Financial data 1008 comprising information required for invoicing a sponsor is tied to the contract information 1002. License information is stored within a license data store 1006. This includes information concerning activation and association of the license, as well as the life span and pendency of a license, as licenses have a specific life span.

EFT transactions are stored in an EFT data store 1014 in their native format, as well as within the relational data store optimized for data retrieval. A remittance data store 1016 stores remittance information in native original format, as well as relational database format for optimization of data retrieval. A tracking data store 1010 provides the audit trail logging portion of the data store. In general, the following items must be logged by the system: user logins, modifications to data, success or failure of data transfer, the data viewed by user, and any modifications to access.

The electronic business process also includes a translation mechanism that various file formats, such as proprietary flat files for payment data into 835 format, and vice-versa; 837 Professional formatted data into NSF formatted data, and vice-versa; and 837 Institutional formatted data into EMC (Electronic Medical Claim) formatted data, and vice versa.

As shown in FIG. 4, a provider 402 accesses the system 400 through a provider portal 412. This interface can either be accessed alone or be accessed from a third party application (i.e., a provider's practice management system, a payer provided portal, etc.). In one embodiment, the provider portal 412 includes several components, such as for provider registration, provider login, provider portal administration, and a provider workspace. The provider login component allows a user to enter the system with a user ID and password. Upon successful validation, the user will have access to the system at the appropriate security level. The provider registration allows users to be assigned a valid ID and password, as all providers are required to register to use the system no matter how the service is accessed. Under one embodiment, the provider has two methods of registration. First, he may enter a license key which is provided by the sponsor. This method assumes that the provider information has been bulk loaded into the system. Second, the provider will need to enter all information at time of registration as well as the license key. Once the registration has been completed the license is activated.

The provider workspace component within the provider portal 412 includes a section for uploading of claims. The upload claims section should also have a duplicate claim check in the event the claim comes from more than one sponsor. Providers or the provider's clearinghouse have the ability to upload ASC X12N 837 HIPAA formatted conforming claims. Syntax errors may cause the upload process to fail. The provider can view their claims online, those claims that have remittance associated with them is notated on the screen, and all claims are shown. The end user can sort the list by date of service, date of EFT, most recently updated, without EFT, with EFT, without remittance, with remittance. From the claim, the user can view the remittance and EFT (or EFTs) information associated with the claim, the user can also view the claim detail or line detail information associated with the remittance(s). The provider can view the remittance information for each claim submitted. There may be more than one remittance for each claim.

The provider portal administration section of the provider portal 412 is generally for the provider's super user. This user is referred to as the Provider Office Manager for the purpose of this application. This section allows for the management of licenses, generation of reports, and other administrative tasks. The license management function allows the user to enter new license numbers, view licenses, renew licenses, or delete licenses. The provider may have more than one license potentially provided by more than one sponsor. The end user can delete a license from their account. This may be performed if a provider switches sponsors. For entry of a new number, the end user is provided with the format of XXXXXX-XXXXXX-XXXX. The number is validated by the system. In general, each license has the life span of two years. The provider can renew their license if applicable via the renew license. In this case, the system sends a message to the sponsor at a set period of time (e.g., three months) prior to expiration to renew the license on behalf of the provider.

The practice profile function of the provider portal administration section allows the user to maintain and manage location information of the provider. This function allows the user to enter delete locations, or enter the location or location address that service will occur. Each location must be entered, and an organization profile must exist, which is the default information for the organization.

A provider management area in the provider portal administration section allows for keeping track of the provider's ID's and locations. This data is utilized in reporting information such as: billing/payment per service by provider, provider type (provider taxonomy), by location, and so on. A provider selection function allows a provider to be selected and associated to a location. Providers can be linked to more than one location, and each location can have more than one provider. Once the provider has been chosen, the end user enters the type of ID that is associated to this provider. The ID type is controlled by the system, and only ID's of payer supported by trading partner agreements can be stored or entered. An association between the provider and the ID can also be deleted. Any changes in this area will also need to be logged and audited, and entries go in the tracking data store.

A reporting function within the provider portal administration section allows the user to generate different types of reports. A Payment Detail by Provider report contains payments based on a rendering provider ID for a specified time frame; a Payment Detail by Service Type shows payment detail by service type for a specified time frame; a Receivables Report provide the ability for the provider to view their receivables for a specific time frame. This report would be from the aspect of the EFT and all associated claim and remittance details associated with the EFT; a Claims Accepted for Adjudication report is a report of all claims data uploaded into the system for the organization for a specified timeframe. In general, every payer will have custom reports that are required to be sent to the provider. These reports will differ in format and content for each payer. The reports are available in their ‘raw’ format for the provider. The report files are saved to the provider's desktop for viewing. These reports would be proprietary EOB reports, and so on.

A user administration function within the provider portal administration section constitutes an area where the office manager can add users for the staff to use the provider portal. The super user will assign access to the major areas of functionality, such as: provider app administration, staff login, and provider workspace. The super user can remove access from this interface as well. The ability to disable an account occurs at from this interface as well. The office manager or super user is the initial member ID that is created when the organization registered. This user can add other users/ID's to the system or modify the users.

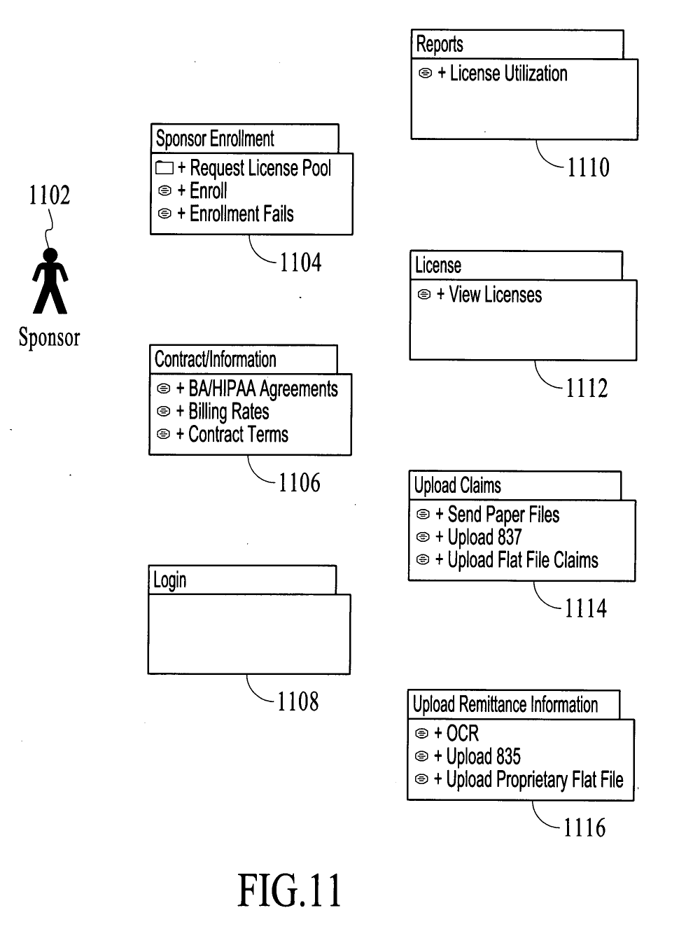

As shown in FIG. 4, a sponsor 404 accesses the system 400 through a sponsor portal 414. The sponsor portal provides for the management of licenses, reports, and contract information. FIG. 11 illustrates the functional components within the sponsor portal, under an embodiment. The basic components include a sponsor enrollment component 1104, a contract information component 1106, a login area 1108, a reports area 1110, a licenses area 1112, a claim upload component 1114, and a remittance information upload component 1116.

Each sponsor will enroll the organization into the system. In one embodiment, the following information is used for enrollment:
1. Organization Name
2. Organization Address
3. Organization City/State/Zip
4. Organization Phone Number
5. Organization Contact Name
6. Organization Contact Email
7. Organization Contact Phone Number
8. Organization Contact Fax Number
9. Organization Tax Identification Number
10. Organization User ID
11. Organization Password

If the enrollment process fails, the BDM is instructed to contact the system sales contact. As part of enrollment, the sponsor staff member can use the license pool to assign or send a license to their clients.

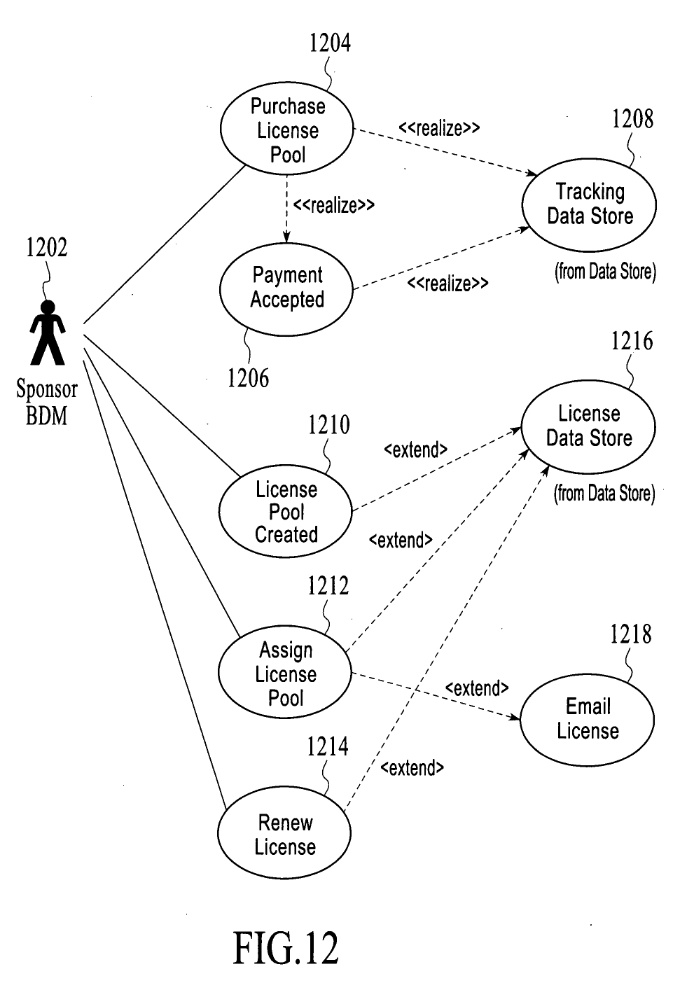

FIG. 12 illustrates the request license pool process for a sponsor, according to an embodiment. As shown in FIG. 12, the sponsor 1202 purchases a license pool 1204. If payment is accepted, 1206, a license pool is created, 1210. The purchase and payment transactions are tracked in a data store, 1208. In one embodiment, licenses have a life span of two years, thus the sponsor will need to renew licenses, 1214. The sponsor can assign a license pool 1212, and licenses are e-mailed to the sponsor's clients, 1218. All created, assigned, and renewed licenses are stored in a license data store 1216.

As shown in FIG. 11, the sponsor portal includes an upload claims component 1114. The sponsor can send paper claims to the system OCR center. For 837 claims, the sponsor will create an EDI interface to upload claims information. These are pre-adjudication claims. For flat file claims, the sponsor will upload proprietary claims files. These are also pre-adjudication claims. The sponsor's IT staff or service will upload the EFT information to the system. This may be either a manual process or may be automated.

The sponsor portal also includes a remittance information upload module 1116. In one embodiment, the sponsor staff will upload scanned paper remittances and EOBs to the system for processing. The outsourced resources will then perform validation checks on any images that need manual intervention prior to loading the information into the database. This will then be sent to the system in a system canonical format. For 835 forms, the sponsor's staff or system will upload the ASC X12N 835 transaction. The system will accept the 005010,004050,004010, 004010A1 and the 003051 versions of the 835. For flat files, the sponsor's staff member/system will upload a proprietary file. Each file undergoes a ‘translation’ into the system canonical format. The sponsor can also view invoice information, such as current and unpaid invoices, as well as payment history.

The contract information module of the sponsor portal allows current BA agreements or other HIPAA legal agreements to be displayed. The sponsor must have acceptance on file for any license to be considered current. This module also displays the current billing rates that apply to the contracted services, and the current contract language, effective dates and limitations.

Through the sponsor portal, the sponsor has the ability to view all licenses, provider information tied to each license, activation status of the provider, and expiration dates for those licenses. The reports module 1110 of the sponsor portal reports on the activation of the license pool associated with the sponsor.

In one embodiment, the electronic business system creates an integrated healthcare payment system from component systems and documents to create a fully-balanced, more completely-coded, HIPAA standard ASC 12N 835 remittance file that can be auto-posted into any practice management system at the push of a button, and is interoperable with practice management systems, electronic health record systems, a dashboard system, and an OCR system. The database of the system is configured to hold all data related to the encounter, claim, remittance, payment, and explanation of benefits (EOB) documentation. The EOB information is gathered from paper documentation utilizing an OCR product that uses dynamic character recognition technology to identify and extract data from the paper EOB.

The remark and reason codes on paper EOBs are typically proprietary and more detailed than the generic codes utilized in the current HIPAA standard. A cross reference is developed from the generic codes to the more detailed codes. In addition, the proprietary codes are associated with claim adjustment amounts that will allow the remittance system to make determinations on balancing both at the claim and service line level within the standard remittance transaction set. Once the claim, remittance, payment and EOB documentation have been completely loaded, the system will compare the claim amount to the remittance, payment, and EOB amounts and if not fully balanced at this point utilize the detailed codes captured from the EOB to make balancing determinations. The submitted claim charges minus the sum of all monetary adjustments, whether positive or negative, equals the claim payment amount. Because of the more complete data capture methods of this comprehensive system, a completely balanced ASC X12N 835 remittance will be output and will auto-post into any practice management system.

The comprehensive data store containing claim diagnosis, procedure, and payment information will supply decision support data to the dashboard component. Decision support includes population health, accounts receivables days outstanding, over payment, under payment, and many other reports. The dashboard component presents the information in a graphical format and allows the user to drill down to the data level.

The EHR component contains a biometric device for finger image capture/comparison, an OCR component that allows for the scanning of a drivers license or health insurance card or other ID, a magnetic strip reader to gather demographic information from the patient and allow for pre-payment of co-pay amounts via debit/credit if a financial card is provided, a touch screen for kiosk-type interaction, bar code reader for tracking medications, and a camera for layered biometrics. The combination of these items allow for a consistent enrollment process that will perform eligibility functionality as well as ensure the patient is who they claim they are via biometric verification. This helps limit the potential for fraud and abuse that currently occurs in many healthcare systems.

Although embodiments are described as directed to specific implementations with regard to forms, formats and the like, such as HIPAA requirements, and HIPAA-specific formats, it should be noted that these are intended to primarily be illustrative in nature, and that many other types of formats, claims, remittances, licenses, and the like are possible.

Although aspects of certain embodiments are directed to processing of service provision and payments in the medical industry with particular relevance to managed healthcare providers, it should be noted that alternative embodiments can be directed to other industries for the provision of many other types of professional services, such as, but not limited to insurance, accounting, engineering, legal, education and the like.

Aspects of the electronic business process described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the electronic business process is not intended to be exhaustive or to limit the embodiments to the precise form or instructions disclosed. While specific embodiments of, and examples for, the electronic business process are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the online loan application system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method of processing remittances to a provider from a payer based on services provided to a patient in a provider practice management system, comprising:
storing encounter, claim, remittance, payment and explanation of benefits information in a database for the practice management system, wherein the explanation of benefits contain detailed codes utilized by the practice management system;
cross referencing generic codes in the explanation of benefits information from the detailed codes to generic codes defined by a government regulatory act; and
associating the detailed codes with claim adjustment amounts to allow a remittance system to make remittance determinations within a standard remittance transaction set defined by the government regulatory act.

2. The method of claim 1 wherein the explanation of benefits information is obtained from paper documentation using an optical character recognition process that uses dynamic character recognition technology to identify and extract data regarding the patient.

3. The method of claim 2 wherein government regulatory act comprises the Health Insurance Portability and Accountability Act of 1996 (HIPAA), and wherein the paper documentation includes remark and reason codes that are more detailed than generic codes utilized in a current HIPAA standard.

4. The method of claim 3 wherein the remittance file comprises a HIPAA standard ASC12N 835 remittance file that is configured to be auto-posted into the practice management system.

5. The method of claim 3 further comprising comparing a claim amount to a loaded remittance, payment, and explanation of benefit amounts to determine whether the claim amount is balanced is balanced.

6. The method of claim 5 wherein if the claim amount is not balanced, using the detailed codes from the explanation of benefits to make balancing determinations for the claim amount relative to the loaded remittance, payment and explanation of benefit amounts.

7. The method of claim 6 wherein a submitted claim charge minus any adjustments is equal to a claim payment amount.

8. The method of claim 1 further comprising obtaining information from the patient using a biometric device configured to read a characteristic of the patient's body.

9. The method of claim 1 further comprising using claim, diagnosis, procedure, and payment information to supply a decision support component.

10. The method of claim 9 wherein the claim, diagnosis, procedure, and payment information is provided to a user in a graphical format displayed through a graphical user interface displayed on a client computer operated by the user.

11. A system for creating a fully-balanced, completely coded, HIPAA standard remittance file comprising:
a remittance component configured to automatically convert paper and electronic remittance and payment data into validated electronic information that is compliant with HIPAA Administrative Simplification standards;
an electronic health record component configured to automatically update personal and electronic health records of a patient receiving treatment from a health professional; and
a dashboard component configured to provide reporting functions to at least one of the patient, the health professional and a payer of fees for the treatment.

12. The system of claim 11 further comprising a database configured to store all data related to the encounter, claim, remittance, payment, and explanation of benefits documentation.

13. The system of claim 12 further comprising a biometric component for gathering of patient information from the body of the patient.

14. The system of claim 13 further comprising an optical character recognition module configured to allow automated gathering of patient information for documentation related to the patient.

15. The system of claim 11 wherein the remittance file comprises a HIPAA standard ASC12N 835 remittance file that is configured to be auto-posted into a practice management system.

16. A system for processing remittances to a provider from a payer based on services provided to a patient in a provider practice management system, comprising:
providing a provider portal allowing a provider to access a system containing a remittance component, an electronic health record component, and a graphical user interface component;
providing a sponsor portal allowing a sponsor to access the system, wherein the sponsor comprises an entity that has contracted the services of the system or has purchased a right of access to the system, wherein the right of access consists of a licensing mechanism managed by a system administrator; and
providing an interface to a payer, wherein the payer comprises an entity responsible under HIPAA for communicating remittance advice in ASC X12N 835 format to the provider.

17. The system of claim 16 wherein the provider is one of a billing service or a large organization having multiple locations.

18. The system of claim 17 wherein the remittance component configured to automatically convert paper and electronic remittance and payment data into validated electronic information that is compliant with HIPAA Administrative Simplification standards.

19. The system of claim 18 wherein the electronic health record component is configured to automatically update personal and electronic health records of a patient receiving treatment from a health professional, and the graphical user interface component is configured to provide reporting functions to at least one of the patient, the provider, and the payer.

20. The system of claim 19 further comprising a database configured to store all data related to the encounter, claim, remittance, payment, and explanation of benefits documentation.
